(19) United States
(12) Patent Application Publication
(10) Pub. No.: US 2024/0241361 A1
(43) Pub. Date: Jul. 18, 2024

(54) MONOCULAR BRIDGE ASSEMBLY

(71) Applicant: Trent Zimmer, Youngsville, LA (US)

(72) Inventor: Trent Zimmer, Youngsville, LA (US)

(21) Appl. No.: 18/414,368

(22) Filed: Jan. 16, 2024

Related U.S. Application Data
(60) Provisional application No. 63/439,224, filed on Jan. 16, 2023.

(51) Int. Cl. G02B 23/12

(52) U.S. Cl. CPC G02B 23/125

(57) ABSTRACT

Disclosed is a bridge assembly for a monocular optical device. The bridge assembly allows for an attached optical device to be positioned in front of either the user's left or right eye. This repositioning of the optical device is achieved by laterally sliding the adapter plate, which connects the optical device to the bridge assembly, to align the eyepiece of the optical device with the desired eye. In some implementations, the ridge assembly is configured to enable the user to adjust the pupillary distance of the optical device.

### CROSS-REFERENCE TO RELATED APPLICATION(S)

This application claims the benefit of U.S. Provisional Application Ser. No. 63/439,224, filed on Jan. 16, 2023, the entirety of which is incorporated herein by reference.

### TECHNICAL FIELD

This disclosure relates to a monocular bridge assembly used to couple an optical device, such as a night vision goggle, to a helmet or other headgear equipped with a suitably configured mount interface, often referred to as a shroud.

### BACKGROUND

Monocular bridge mounts offer a mounting solution for attaching a monocular optical device to headgear, such as a helmet. These bridge mounts are particularly useful in scenarios where hands-free operation is essential, such as in military, law enforcement, and recreational activities. Helmets suitable for this purpose typically feature a dedicated mount, referred to as a shroud, designed to removably receive a compatible mount that is attached to the optical device. This setup ensures a stable connection between the helmet and the optical device, which is crucial for operational efficiency and user comfort. While binocular bridge mounts are available, monocular optical devices are sometimes preferred due to cost, weight, and other considerations. However, during operational use, it can be useful for users to have the flexibility to move a monocular optical device between different viewing positions, accommodating both the left and right eyes.

Accordingly, needs exist for the monocular bridge assembly disclosed herein. It is to the provision of a monocular bridge assembly configured to address these needs, and others, that the present invention is primarily directed.

### SUMMARY OF THE INVENTION

It is to be understood that this summary is not an extensive overview of the disclosure. This summary is exemplary and not restrictive, and it is intended neither to identify key or critical elements of the disclosure nor delineate the scope thereof. The sole purpose of this summary is to explain and exemplify certain concepts of the disclosure as an introduction to the following complete and extensive detailed description.

Disclosed is a bridge assembly for a monocular optical device. The bridge assembly allows for an attached optical device to be selectively positioned in front of either the user's left or right eye. This repositioning of the optical device is achieved by laterally sliding the adapter plate, which connects the optical device to the bridge assembly, to align the eyepiece of the optical device with the desired eye. In some implementations, the bridge assembly is configured to enable the user to adjust the pupillary distance of the attached optical device.

An example bridge assembly comprises a mounting shoe, a stem portion attached to the mounting shoe, a sliding arm member slidably coupled to the stem portion, and an adapter plate slidably coupled to the sliding arm member. The adapter plate includes an attachment interface to which the optical device is coupled. The adapter plate is configured to be laterally displaced between a first position that places the monocular optical device in front of a first eye of a user and a second position that places the monocular optical device in front of a second eye of the user.

### BRIEF DESCRIPTION OF THE DRAWINGS

FIG. 1 is an isometric view of an optical device coupled to a monocular bridge assembly consistent with the principles of the present disclosure.

FIG. 2 is a front plan view of the optical device coupled to the monocular bridge assembly shown in FIG. 1. In this view, the optical device is in a first position.

FIG. 3 is another front plan view of the optical device and monocular bridge assembly shown in FIG. 1. In this view, the optical device is in a second position.

FIG. 4 is an isometric view of the monocular bridge assembly shown in FIG. 1.

FIG. 5 is an exploded isometric view of the monocular bridge assembly shown in FIG. 4.

FIG. 6 is another isometric view of the monocular bridge assembly shown in FIG. 4.

FIG. 7 is a top plan view of the monocular bridge assembly shown in FIG. 4.

FIG. 8 is a side elevational view of the monocular bridge assembly shown in FIG. 4.

FIG. 9 is a side cutaway view of the monocular bridge assembly taken along lines 9-9 shown in FIG. 7.

FIG. 10 is a side cutaway view of the monocular bridge assembly taken along lines 10-10 shown in FIG. 7.

FIG. 11 is an isometric view of a sliding arm member of the monocular bridge assembly shown in FIG. 4.

FIG. 12 is a top plan view of the sliding arm member shown in FIG. 11.

FIG. 13 is a bottom plan view of the sliding arm member shown in FIG. 11.

FIG. 14 is a side elevational view of the sliding arm member shown in FIG. 11.

FIG. 15 is an isometric view of an adaptor plate of the monocular bridge assembly shown in FIG. 4.

FIG. 16 is a top plan view of the adapter plate shown in FIG. 15.

FIG. 17 is a side elevational view of the adapter plate shown in FIG. 15.

Like reference numerals refer to corresponding parts throughout the several views of the drawings.

### DETAILED DESCRIPTION

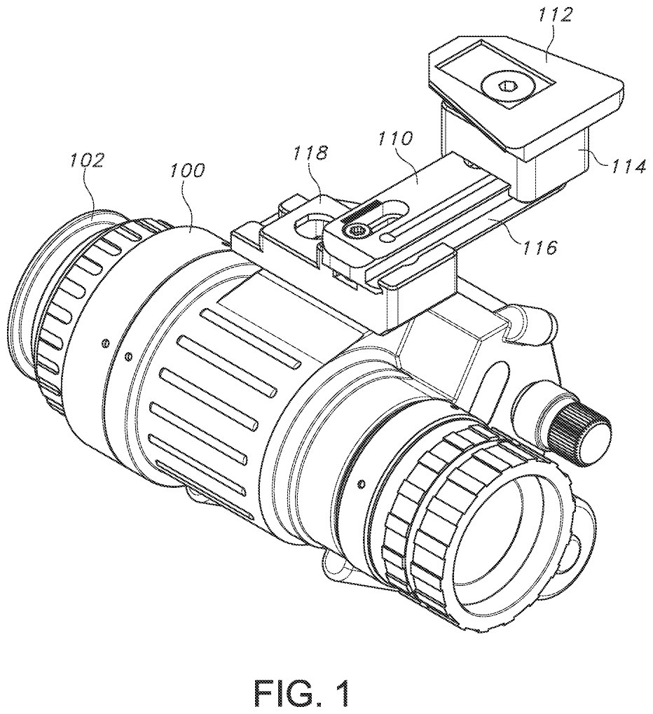

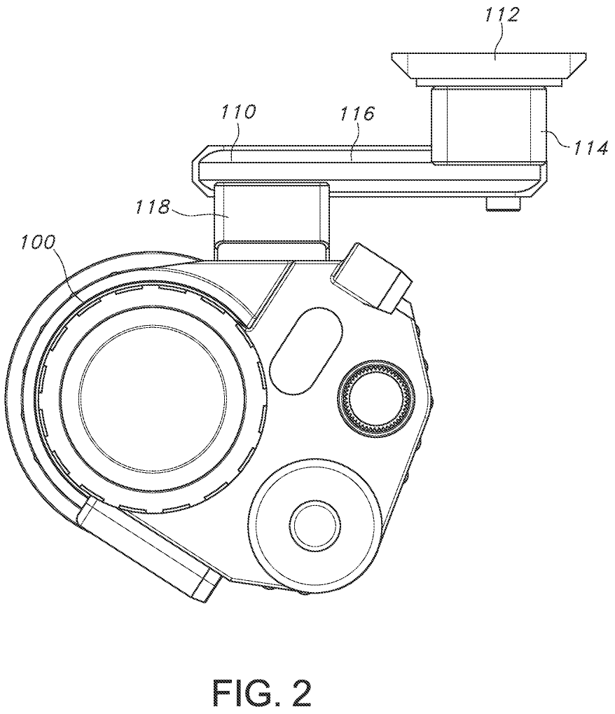

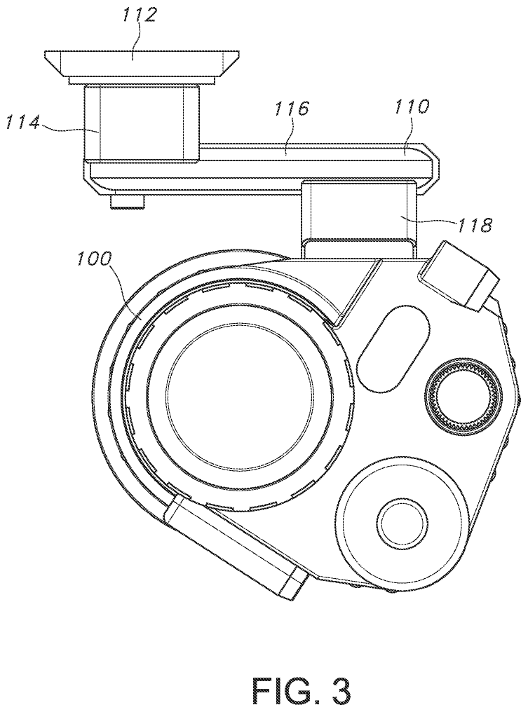

FIGS. 1-3 illustrate an optical device 100 coupled to a monocular bridge assembly 110 consistent with the principles of the present disclosure. The optical device 100 is a PVS-14 night vision device. However, it will be recognized that the monocular bridge assembly 110 may be adapted for use with other monocular optical devices. The monocular bridge assembly 110 is configured to allow a user to alternatively position an eyepiece 102 of the optical device 100 in front of a right eye (see, e.g., FIG. 2) or a left eye (see, e.g., FIG. 3) of the user. The monocular bridge assembly 110 is also configured to enable a user to set the pupillary distance of the attached optical device 100.

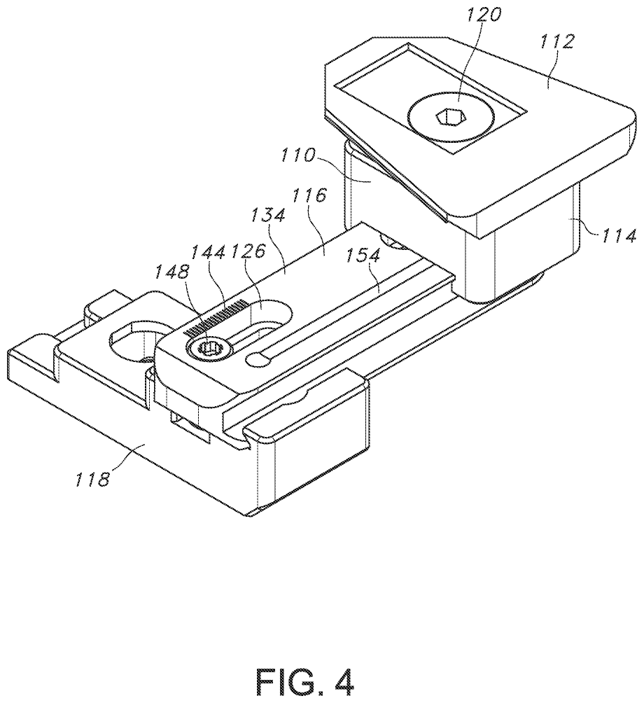

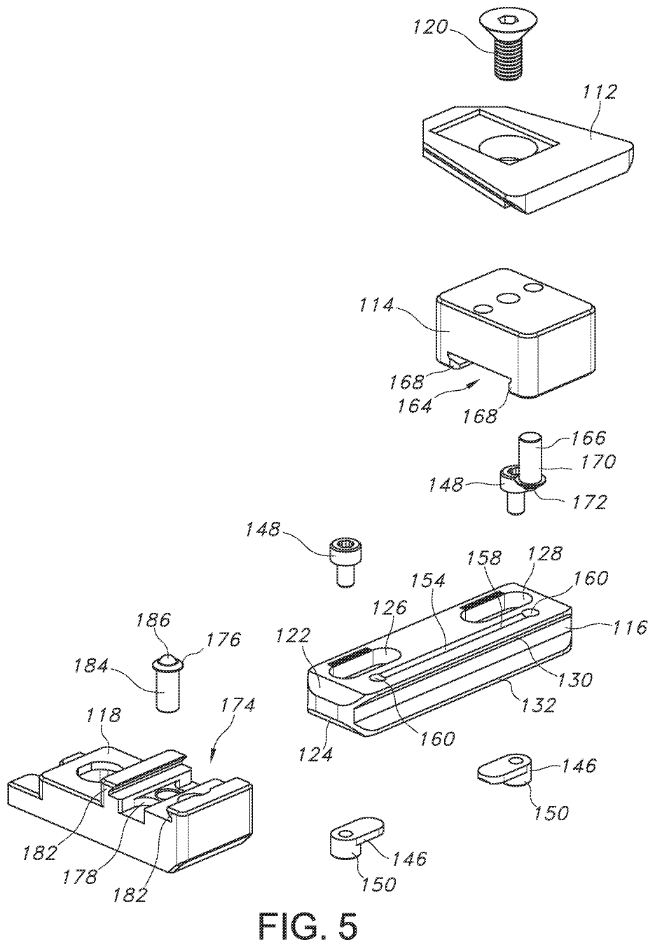

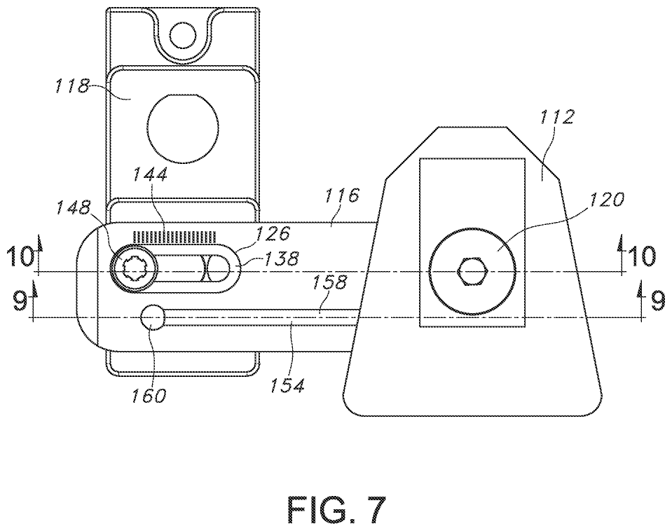

As shown best in FIGS. 4-8, in some implementations, the monocular bridge assembly 110 comprises a mounting shoe 112, a stem portion 114, a sliding arm member 116, and an adapter plate 118 for the optical device 100.

The mounting shoe 112 of the monocular bridge assembly 110 is configured to cooperate with and be removably coupled to a helmet mount, such as a G24 mount sold by Wilcox Industries Corp. The mounting shoe 112 is secured to the stem portion 114 of the monocular bridge assembly 110 by a threaded fastener 120.

The sliding arm member 116 of the monocular bridge assembly 110 comprises an upper portion 122, a lower portion 124, and two slots 126, 128. The upper portion 122 includes a dovetail rail 130 and the lower portion 124 includes another dovetail rail 132. The dovetail rail 130 on the upper portion 122 is sized to be slidably coupled to a rail receiving receptacle 164 on an underside of the stem portion 114; the dovetail rail 132 on the lower portion 124 is sized to be slidably coupled to a rail receiving receptacle 174 on a top side of the adapter plate 118. Each of the two slots 126, 126 extend through the sliding arm member 116, between a top side 134 and a bottom side 136 thereof. Each slot 126, 128 includes an interior annular ledge 138, dividing the slot into a top groove 140 and a bottom groove 142. Hash marks 144 or other indicia are positioned adjacent the top groove 140 of each slot, the purpose of which will be described below.

The sliding arm member 116 further comprises a longitudinally extending detent track 154 on the top side 134 and another longitudinally extending detent track 156 on the bottom side 136. The longitudinally extending detent track 154 on the top side 134 includes a longitudinally extending groove 158 having a detent 160 on each end. Each detent 160 is shaped to receive a ball. The longitudinally extending detent track 156 on the bottom side 136 includes a longitudinally extending groove 162 and the detent 152 of each overtravel stop 146, described in detail below.

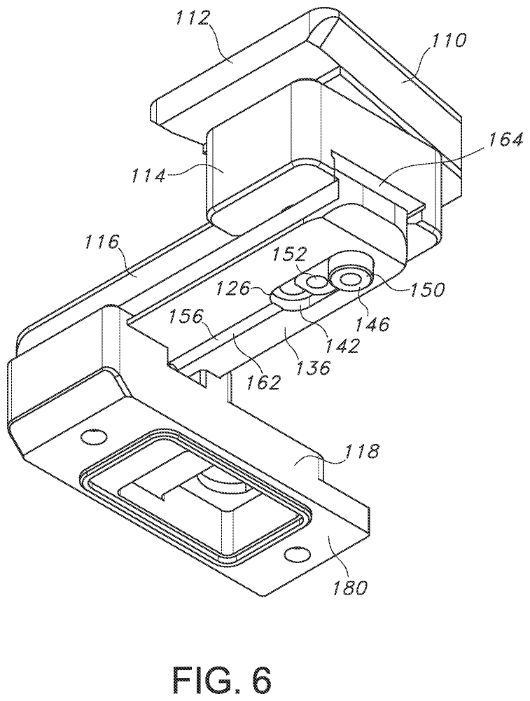

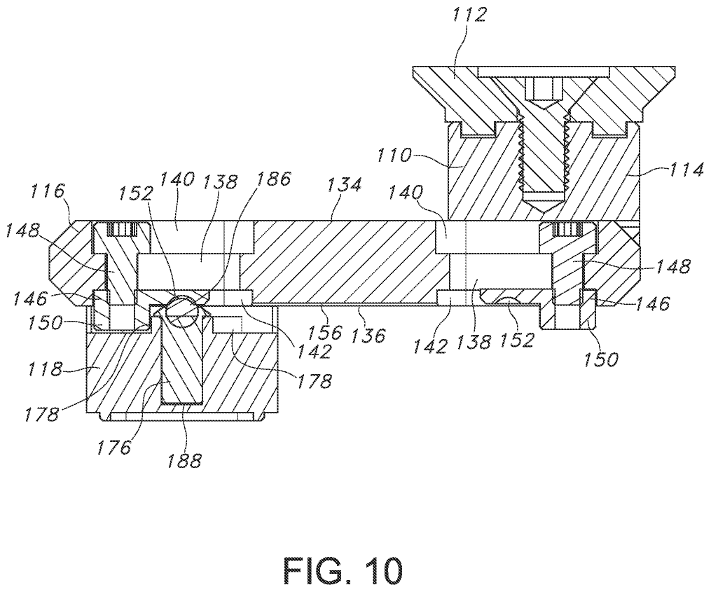

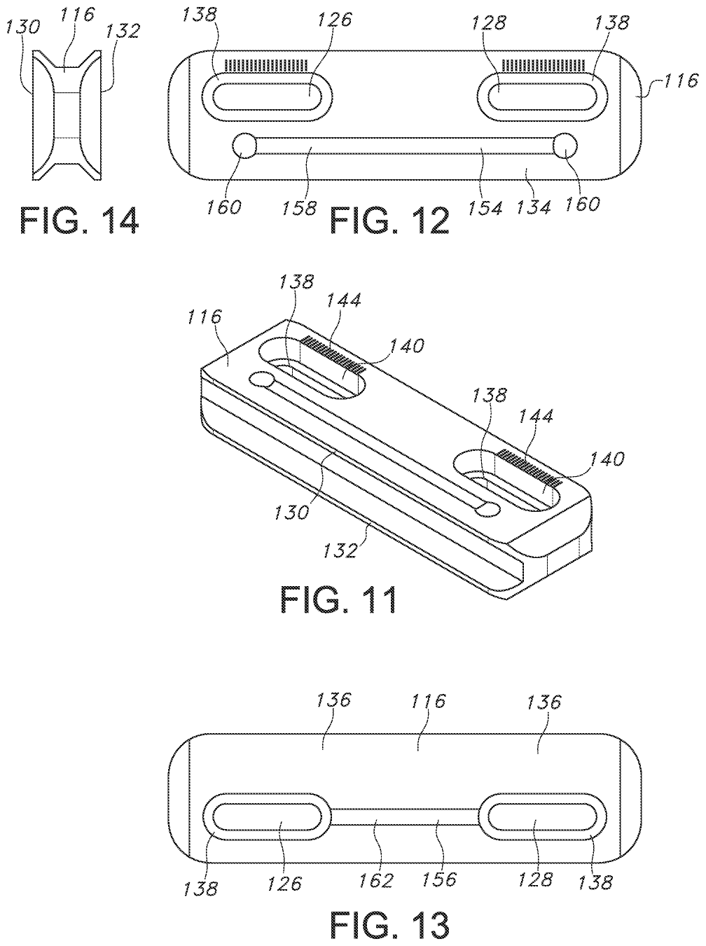

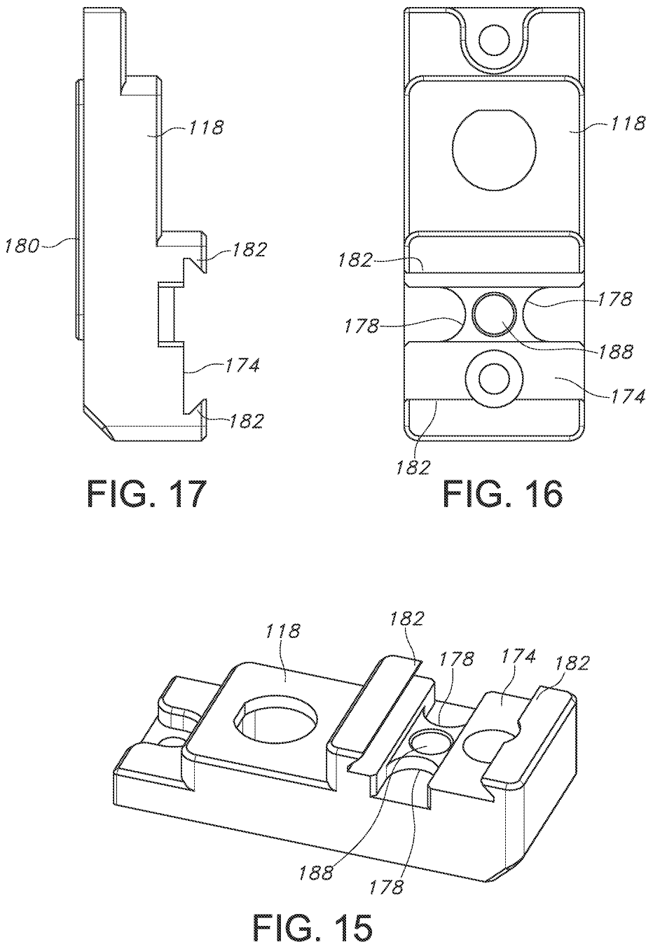

An overtravel stop 146 is positioned within the bottom groove 142 of each slot 126, 128 in the sliding arm member 116. Each overtravel stop 146 is fixed in position within the bottom groove 142 of a slot 126, 128 by a fastener 148 nested within the top groove 140 of the same slot 126, 128. By loosening the fastener 148, an overtravel stop 146 can be slidably repositioned within the bottom groove 142. In this way, the user can set the pupillary distance of the attached optical device 100 for each eye. Each overtravel stop 146 comprises a cylindrical boss 150, a portion of which extends from the bottom groove 142, and a detent 152 (see, e.g., FIG. 6). The fastener 148 may be threadedly secured within a bore in the cylindrical boss 150 of the overtravel stop 144. The detent 152 is on a downwardly facing surface of the overtravel stop 144 and forms a portion of the longitudinally extending detent track 156 on the bottom side 136 of the sliding arm member 116 (see, e.g., FIG. 10).

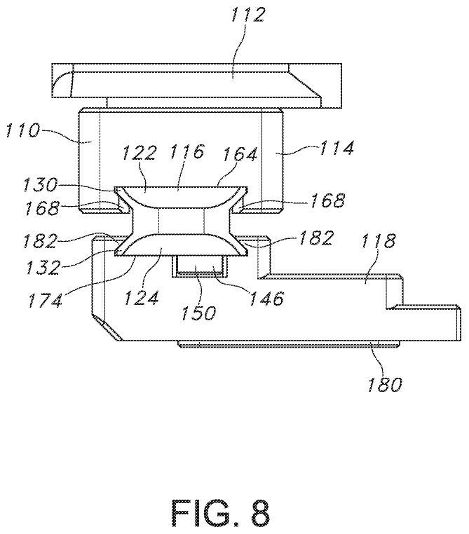

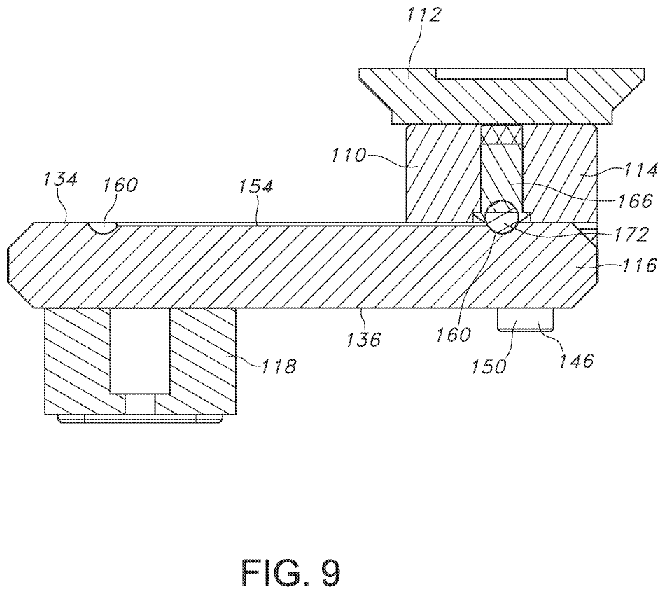

The stem portion 114 of the monocular bridge assembly 110 comprises the rail receiving receptacle 164 and a ball plunger assembly 166. The rail receiving receptacle 164 may include a pair of parallel engagement members 168 configured to cooperate with the dovetail rail 130 on the upper portion 122 of the sliding arm member 116 (see, e.g., FIG. 8). The ball plunger assembly 166 is nested within a bore in a downwardly facing surface of the rail receiving receptacle 164, between the engagement members 168. The ball plunger assembly 166 comprises a housing 170 and a spring-loaded ball 172. The bore is positioned so that the spring-loaded ball 172 is placed into operational contact with the longitudinally extending detent track 154 on the top side 134 of the sliding arm member 116 (see, e.g., FIG. 9). In this way, the spring-loaded ball 172 is positioned to cooperate with one of the detents 160 and thereby temporary fix the sliding arm member 116 in either a first position, shown in FIG. 2, or a second position, shown in FIG. 3. Also, it should be understood that further lateral movement of the sliding arm member 116 is prevented by the spring-loaded ball 172 engaging the detent 160 on either end of the longitudinally extending detent track 154.

The adapter plate 118 of the monocular bridge assembly 110 is configured to slide transversely along the sliding arm member 116 between two positions, enabling the user to alternatively position the eyepiece of the optical device in front of the right eye or left eye of the user. The adapter plate 118 comprises the rail receiving receptacle 174, a ball plunger assembly 176, two end stops 178, and an attachment interface 180. The rail receiving receptacle 174 may include a pair of parallel engagement members 182 configured to cooperate with the dovetail rail 132 on the lower portion 124 of the sliding arm member 116 (see, e.g., FIG. 8). The ball plunger assembly 176 is nested within a bore 188 in an upwardly facing surface of the rail receiving receptacle 174, between the engagement members 182. The ball plunger assembly 176 comprises a housing 184 and a spring-loaded ball 186. The bore 188 is positioned so that the spring-loaded ball 186 is placed into operational contact with the longitudinally extending detent track 156 on the bottom side 136 of the sliding arm member 116 (see, e.g., FIG. 10). Each of the two end stops 178 are positioned adjacent to, and on opposite sides of, the bore 188 for the ball plunger assembly 176 (see, e.g., FIG. 16). Each of the end stops 178 is an arcuate surface configured to engage the cylindrical boss of an overtravel stop 144 when either directional travel limit of the adapter plate 118 is reached (see, e.g., FIG. 10). The attachment interface 180 on the bottom side of the adapter plate 118 is configured so that the optical device 100 can be attached thereto. While the example optical device 100 is a PVS-14 night vision device, the attachment interface 180 of the adapter plate 118 can be configured to facilitate the attachment of other monocular optical devices, such as night vision devices, thermal imaging devices, and SWIR (short wave infrared) imaging devices.

The mounting shoe 112, the stem portion 114, the sliding arm member 116, and the adapter plate 118 may be fabricated from an aluminum alloy, or another suitable material.

### USE AND OPERATION

The monocular bridge assembly 110 can be used to alternatively position the optical device 100 in front of the right eye or the left eye of the user. In particular, the optical device 100 can be moved between the two positions by simply sliding the adapter plate 118 towards the position that places the eye piece 102 of the optical device 100 in front of the desired eye.

In operation, the adapter plate 118 will slide transversely along the sliding arm member 116, towards the desired position, until one of the end stops 178 engages the cylindrical boss 150 of an overtravel stop 146 and the spring-loaded ball 186 of the ball plunger assembly 176 engages the detent 152 of the overtravel stop 146. This positions the adapter plate 118 on one end of the sliding arm member 116. Further lateral movement of the adapter plate 118 causes the sliding arm member 116 to slide through the rail receiving receptacle 164 of the stem portion 114 until the spring-loaded ball 172 of the ball plunger assembly 166 engages the detent 160 at the end of the longitudinally extending detent track 154 on the top surface 154 of the sliding arm member 116. In this way, the optical device 100 is positioned in front of the desired eye by the user. If needed, the pupillary distance can now be adjusted by loosening the fastener 148 and repositioning the overtravel stop 146 within the bottom groove 142 of the appropriate slot (126 or 128).

The foregoing description of the invention is intended to be illustrative; it is not intended to be exhaustive or to limit the claims to the precise forms disclosed. Those skilled in the relevant art can appreciate that many modifications and variations are possible in light of the foregoing description and associated drawings.

Reference throughout this specification to an “embodiment” or “implementation” or words of similar import means that a particular described feature, structure, or characteristic is included in at least one embodiment of the present invention. Thus, the phrase “in some implementations” or a phrase of similar import in various places throughout this specification does not necessarily refer to the same embodiment.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

1. A bridge assembly for a monocular optical device, the bridge assembly comprising:
a mounting shoe;
a stem portion attached to the mounting shoe;
a sliding arm member slidably coupled to the stem portion; and
an adapter plate slidably coupled to the sliding arm member, the adapter plate includes an attachment interface to which the monocular optical device is coupled;
wherein:
the adapter plate is configured to be laterally displaced between a first position that places the monocular optical device in front of a first eye of a user and a second position that places the monocular optical device in front of a second eye of the user.

2. The bridge assembly of claim 1, wherein the sliding arm member comprises an upper portion that includes a dovetail rail and a lower portion that includes a dovetail rail, the dovetail rail on the upper portion is slidably coupled to a rail receiving receptacle on an underside of the stem portion, and the dovetail rail on the lower portion is slidably coupled to a rail receiving receptacle on a top side of the adapter plate.

3. The bridge assembly of claim 2, wherein the rail receiving receptacle on the stem portion includes a pair of parallel engagement members configured to cooperate with the dovetail rail on the upper portion of the sliding arm member; the rail receiving receptacle on the adapter plate includes a pair of parallel engagement members configured to cooperate with the dovetail rail on the lower portion of the sliding arm member.

4. The bridge assembly of claim 3, wherein the sliding arm member further comprises a longitudinally extending detent track on a top side of the sliding arm member and a longitudinally extending detent track on a bottom side of the sliding arm member; the stem portion includes a ball plunger assembly disposed within a bore in a downwardly facing surface of the rail receiving receptacle, a spring-loaded ball of the ball plunger assembly is in operational contact with the longitudinally extending detent track on the top side of the sliding arm member; the adapter plate includes a ball plunger assembly disposed within a bore in an upwardly facing surface of the rail receiving receptacle, a spring-loaded ball of the ball plunger assembly is in operational contact with the longitudinally extending detent track on the bottom side of the sliding arm member.

5. The bridge assembly of claim 4, wherein the sliding arm member further comprises a first slot and a second slot; the first slot extends through the sliding arm member, between the top side and the bottom side thereof, and includes an interior annular ledge that divides the first slot into a top groove and a bottom groove, an overtravel stop is slidably positioned within the bottom groove of the first slot and fixed in position by a fastener nested within the top groove; the second slot extends through the sliding arm member, between the top side and the bottom side thereof, and includes an interior annular ledge that divides the second slot into a top groove and a bottom groove, an overtravel stop is slidably positioned within the bottom groove of the second slot and fixed in position by a fastener nested within the top groove; the overtravel stop in the first slot and the overtravel stop in the second slot define the first position and the second position, respectively, of the adapter plate.
